(19) United States
(12) Patent Application Publication
(10) Pub. No.: US 2004/0146145 A1
(43) Pub. Date: Jul. 29, 2004

(54) Voice Mail Message Subscription Service

(75) Inventors: George L. KISER JR., Kannapolis, NC (US); Donald E. Wagstaff JR., Concord, NC (US)

Correspondence Address: MORRIS, MANNING & MARTIN LLP, 6000 FAIRVIEW ROAD, SUITE 1125, CHARLOTTE, NC, 28210, US

(73) Assignee: NEXT DIMENSION MARKETING INTELLECTUAL PROPERTY, LLC, Concord, NC (US)

(21) Appl. No.: 10/708,141

(22) Filed: Feb. 10, 2004

(51) Int. Cl. H04M 11/00

(52) U.S. Cl. 379/88.16

(57) ABSTRACT

In an audible message subscription service, a method includes identifying recipients who have elected to subscribe to audible messages pertaining to one or more predefined subject matters; creating such an audible message; and providing the audile message to the identified recipients. A related method of providing audible messages that pertain to one or more particular subject matters to subscribers who have elected to receive the audible messages includes maintaining subscriber specific records. Each record includes distribution indicators of a respective subscriber, with each distribution indicator corresponding to a particular subject matter for which the respective subscriber has elected to receive audible messages. The method further includes creating an audible message pertaining to a certain one of the particular subject matters; associating a distribution indicator with the audible message that corresponds to the certain particular subject matter, and distributing the audible message to each subscriber whose record includes that distribution indicator.

### COPYRIGHT STATEMENT

A portion of the disclosure of this patent document contains material to which a claim for copyright is made. The copyright owner has no objection to the facsimile reproduction by anyone of the patent documents or the patent disclosure as it appears in the Patent and Trademark Office patent file or records, but reserves all other copyright rights whatsoever.

### BACKGROUND OF INVENTION

Modern lifestyles and careers involve frequent and extensive telephone communications that must reach people who travel from the home to the office and who travel to and from destinations on business. To address some needs of people with such modern lifestyles and careers, voice mail service providers offer telephone contact numbers and receive voice mail messages that can be accessed from any phone at any time at the convenience of recipients of the voice mail services. Typically, the telephone contact number is toll free.

In some cases, voice mail service providers also provide voice mail message forwarding or voice mail message notification services. In voice mail message forwarding services, voice mail messages are forwarded upon receipt to one or more other destinations of the service recipients. In voice mail message notification services, notifications of the receipt of voice mail messages are generated and sent to one or more destinations of the service recipients. Such service providers also offer facsimile capabilities, wherein recipients of the voice mail services may receive and send facsimile transmissions. Voice mail service providers thus insure that communications remain convenient and contiguous to service recipients throughout relocations of residence, changes of employment, and domestic and international travel.

Current service recipients thus benefit from communication capabilities that, in a sense, travel with them or are uninterrupted as travel, relocations, and changes in personal and professional situations occur. A telephone number need not be tied to a residence address or a particular employer. Voice mail service providers offer options for one to keep a telephone number despite temporary or lengthy relocations. When residences and employers change, recipients can retain the use of the telephony services avoiding the inconveniences of informing their contacts that a change has been made. A recipient traveling or relocating can maintain the same telephone number and retrieve voice mail messages from missed calls from any telephone.

The use of voice mail services also is not likely to diminish. While busy individuals and traveling professionals stay in touch with families, colleagues, clients and contacts through electronic mail and text based communications, the natural needs and desires for contact through human voice communications persists. Human voice communications are highly expressive, personal, and often spontaneous. Sincerity and emotions are conveyed through intonation, inflection and tempo in a human fashion not easily encoded in any text based format. Receipt of a voice message through a service provider is often warmly received and appreciated by the recipient and often instills a personal sense of belonging, connection and importance. The advent of electronic mail and text based communications thus supplements, but does not supplant, voice mail services. Indeed, a current trend exists of integrating into electronic telephony devices the ability to send and receive electronic mail and text based communications, as illustrated, for example, by the current line of smartphones offered by PalmOne, Inc.

Within this modern world setting, enthusiasm toward and knowledge of sports has become much more than an immensely popular personal past time. Spectator sports are a principle form of entertainment in modern society as demonstrated by the considerable content toward sports in popular media and the showing of sporting events broadcasts in many public places. Many people favor particular sports, leagues, teams, players, and characters related to sports. Sports discussions are common elements of communications in all aspects of personal and professional lives. A knowledge of sports enables one to open discussions that break the ice by offering a common ground of appreciation shared among many people while defining aspects of the interests and character of a speaker.

Indeed, sports interest has come to permeate our professional lives. Business communications including presentations, lectures, and small talk offered to open or personalize negotiations often include elements of sports related trivia and stories. It is often assumed that one informed of sports issues is likely informed of other issues important to many aspects of business, current events, politics, and history.

Nor is this limited to sports. The assumption also applies when one shares knowledge that is not commonly known and is not gleaned from popular existing media. A ready inside angle to information provides real and apparent advantages, and, for example, in modern arenas of collaborating professionals, having an apparent advantage is a real advantage. Thus, appreciation, mastery and dissemination of rare or breaking specialized knowledge can help one to attain respect among peers, colleagues, clients and constituents and can help one attain and succeed in business and in leadership positions.

Accordingly, a need exists for a convenient and easy way to acquire entertaining and empowering information related to topics of interest such as sports, politics, entertainment, religion, professions, and culture. At least one embodiment of the present invention addresses this need in our modern lifestyles and careers. In this regard, a voice mail subscription service is provided, in conjunction with current voice mail services, that keeps subscribers who utilize any telephone abreast of any selected topics of interest, including, for example, sports, politics, entertainment, religion, professions, current events and culture.

### SUMMARY OF INVENTION

The present invention generally relates to a subscription service for audible messages that pertain to one or more particular subject matters and, in particular, to a subscription service for voice mail messages that pertain to one or more predefined subject matters, the subscribers of which are recipients of voice mail services.

An aspect of the present invention includes a method of providing audible messages that pertain to one or more particular subject matters to subscribers who have elected to receive the audible messages. This method may include the steps of maintaining subscriber specific records, wherein each record includes one or more distribution indicators of a respective subscriber, and wherein each distribution indicator corresponds to a particular subject matter for which the respective subscriber has elected to receive audible messages. The method further includes creating an audible message pertaining to a certain one of the particular subject matters and associating a distribution indicator with the created audible message, with the associated distribution indicator corresponding to the certain one of the particular subject matters. The created audible message then is distributed to each subscriber whose record includes the distribution indicator corresponding to the associated distribution indicator of the created audible message. As will be appreciated, the distribution indicator represents a subject matter flag.

Additionally, in this method, each subscriber specific record includes a destination indicator for the subscriber. The destination indicator may comprise, for example, a telephone number or an email address. A destination of the destination indicator may comprise, for example, a telephone, a telephone answering machine, a voice mail inbox, or a telephone answering service. Distributing the audible message may include, for example, transmitting the audible message as a telephony signal in real time, or transmitting the audible message in data packets, wherein the audible message itself may comprise a digital audio file. Distributing the audible message also may include generating an indication of availability of the audible message and distributing the indication of the availability of the audible message.

This method also may include the further step of receiving, from a particular subscriber, an election to receive audible messages pertaining to another particular subject matter; and including in the record of the particular subscriber a distribution indicator corresponding to this other particular subject matter. The method also may include the step of receiving from a new subscriber an election to receive audible messages pertaining to a particular subject matter, and generating a new record for the new subscriber. In this regard, the record that is generated includes a distribution indicator corresponding to the particular subject matter of the election.

In another aspect of the present invention, a method includes the steps of offering, to recipients of voice mail services, subscriptions to voice mail messages pertaining to one or more particular subject matters; and at periodic intervals, both identifying those recipients who have elected to subscribe to voice mail messages of the offering, and providing to the identified recipients a voice mail message of the offering. A fee for the subscription to the voice mail messages of the offering may or may not be charged. If the offer is for subscriptions to voice mail messages pertaining to a plurality of particular subject matters, then a subscription to voice mail messages may be offered on a per subject matter basis, and the method may include a step of charging a subscription fee on a per subject matter basis. If the offer is for subscriptions to voice mail messages pertaining to a plurality of particular subject matters, then the method also may include the step of receiving, from a particular recipient electing to subscribe to voice mail messages, an identification of a selection of particular subject matters out of the plurality of particular subject matters of the offering. The periodic intervals during which the steps of identifying and providing are performed may include days, weeks, or months, and the periodic intervals may be intermittent in any regular or irregular manner.

In yet another aspect of the present invention, a voice mail message subscription service includes a method having the steps of offering to provide voice mail services and, in conjunction therewith, a subscription to voice mail messages pertaining to one or more particular subject matters; at periodic intervals, identifying recipients of the voice mail services of the offering who, pursuant to the offering, have elected to subscribe to the voice mail messages of the offering; and providing to the identified recipients a voice mail message of the offering. In an alternative method, the offer to provide subscriptions to voice mail messages pertaining to one or more particular subject matters is made to current recipients of voice mail services. In either method, a fee for the subscription to the voice mail messages of the offering may or may not be charged. If the offer is for subscriptions to voice mail messages pertaining to a plurality of particular subject matters, then a subscription to voice mail messages may be offered on a per subject matter basis, and the method may include a step of charging a subscription fee on a per subject matter basis. If the offer is for subscriptions to voice mail messages pertaining to a plurality of particular subject matters, then each method also may include the step of receiving, from a particular recipient electing to subscribe to voice mail messages, an identification of a selection of particular subject matters out of the plurality of particular subject matters of the offering. The periodic intervals during which the steps of identifying and providing are performed may include days, weeks, or months, and the periodic intervals may be intermittent in any regular or irregular manner.

The step of providing to identified recipients a voice mail message of an offering includes making a voice mail message of the offering accessible for listening by each of the identified recipients. This may include, for each particular one of the identified recipients, playing the same digital audio file that represents the voice mail message of the offering. Preferably, this includes, for each particular identified recipient, distributing to a voice mail inbox of the particular identified recipient a digital audio file that represents provided voice mail message of offering, such as by copying a digital audio file that represents the voice mail message to the voice mail inbox of the particular identified recipient.

In commercial implementations of the present invention, a voice mail service provider that provides voice mail services to recipients also may perform one or more of the methods of the present invention. Alternatively, a voice mail message provider may create the voice mail messages pertaining to the one or more particular subject matters, in which case the voice mail service provider preferably receives the voice mail messages and makes the voice mail messages accessible through voice mail to the recipients for listening. The voice mail service provider may have some affiliation with the voice mail message provider, or the voice mail service provider may be independent from the voice mail message provider. When there is both a voice mail service provider and a voice mail message provider, and if the voice mail message subscription service includes the step of charging a fee for providing the voice mail message pertaining to the particular subject matter, then the method preferably includes the step of allocating the fee between the voice mail service provider and the voice mail message provider. The fee alternatively may be allocated between the voice mail service provider, the voice mail message provider, and an organization associated with the particular subject matter. Furthermore, the provision of the subscription to voice mail messages pertaining to one or more particular subject matters preferably represents an optional add-on service to voice mail services that are provided or offered to recipients.

The voice mail messages of the subscriptions may be created by the voice mail service provider or the voice mail message provider. In any event, creating the voice mail messages preferably includes the step of recording the voice of a particular person. The particular person may be a person that is famous with respect to one of the particular subject matters. For instance, the subject matter may be stock car racing and the person may be a racecar driver, or the subject matter may be a sports team and the person may be a coach or player on the team. In another instance, the subject matter may also be fishing and the person may be a recognized expert in fishing. In a particular embodiment, the subscribers with respect to a particular subject matter collectively select the particular person whose voice is recorded for one or more voice mail messages pertaining to that subject matter. The collective selection preferably is by vote of subscribers. In this regard, a predefined group of candidates may be presented from which the subscribers may vote.

With reference to any of these aspects, and in accordance with the present invention, a particular subject matter defining or within a subscription may be a sports topic, a political topic, a religious topic, a news topic, a professional or career topic, or other topic of interest or importance. A sports topic, for example, may pertain to a high school sport or team, a college sport or team, a pro sport or team, an Olympic sport or team; or, baseball, football, basketball, hockey, soccer, tennis, golf, bowling, volleyball, wrestling, boxing, skiing, fishing, hunting, automobile racing, boat racing, motorcycle racing, bicycle racing, foot racing, horse racing, or dog racing, or any team, team member, league, or organization thereof.

### BRIEF DESCRIPTION OF DRAWINGS

Preferred embodiments of the present invention will now be described in detail with reference to the accompanying drawings, wherein:

FIG. 1 illustrates a system for providing voice mail services in conjunction with voice mail message subscriptions of the present invention;

FIG. 2 illustrates a first flowchart of steps performed in the system of FIG. 1; and

FIG. 3 illustrates a second flowchart of steps performed in the system of FIG. 1.

### DETAILED DESCRIPTION

As a preliminary matter, it will readily be understood by those persons skilled in the art that the present invention is susceptible of broad utility and application in view of the following detailed description of preferred embodiments. Furthermore, many embodiments as well as adaptations, variations, modifications, and equivalent arrangements, will be apparent from or reasonably suggested by the preferred embodiments described herein without departing from the scope of the present invention. Accordingly, while the present invention is described herein in detail in relation to preferred embodiments, it is to be understood that this disclosure is illustrative and exemplary and is made merely for purposes of providing a full and enabling disclosure of the present invention. The disclosure herein is not intended, nor is to be construed, to limit the scope of the present invention, which is defined by the claims and the equivalents thereof.

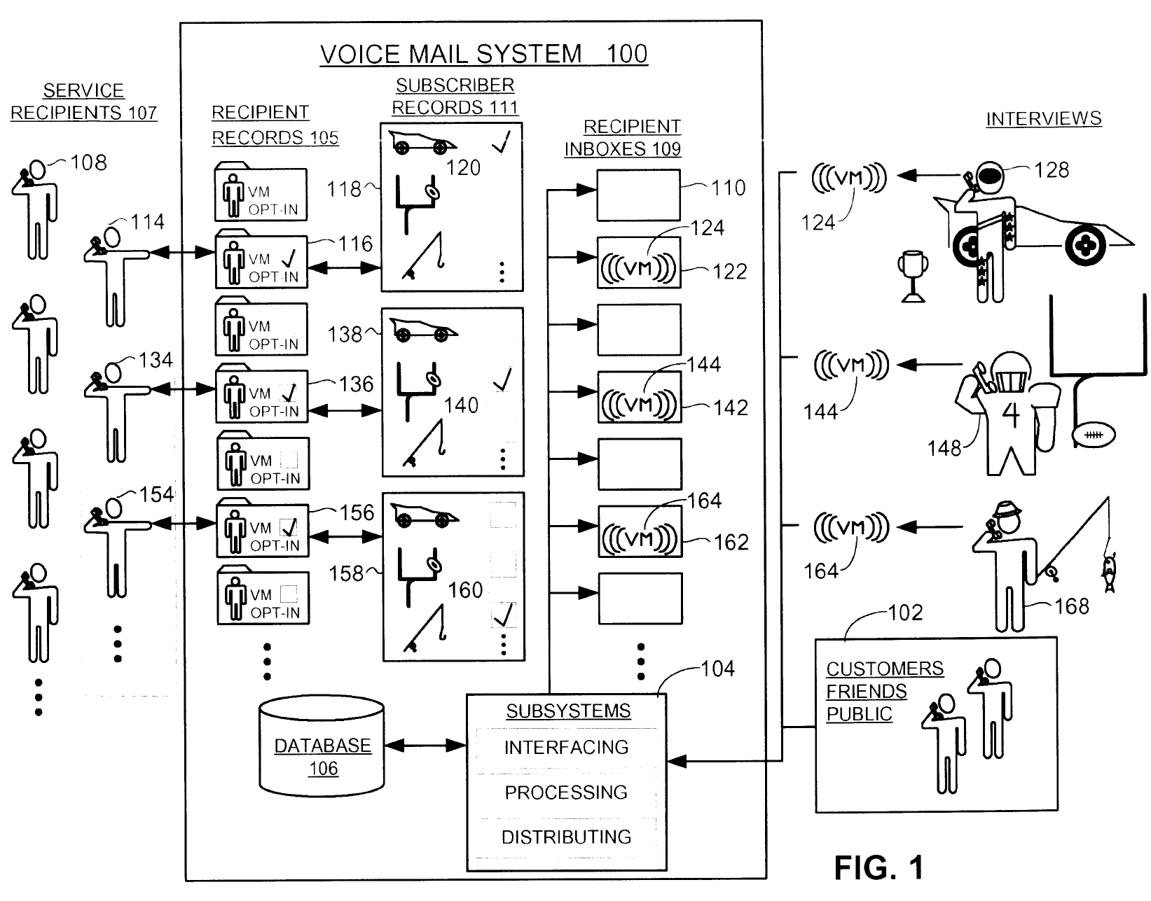

Turning now to FIG. 1, a system for providing voice mail services in conjunction with voice mail message subscriptions is illustrated. In this system, voice mail services are provided to service recipients 107 through a voice mail system 100 of a voice mail service provider. In accordance with the voice mail services, missed calls are recorded as voice mail messages for playback by the service recipients. Typical callers 102 might be customers, friends, or any member of the public wishing to speak to or send voice mail to any particular one of the recipients. Calls in this context represent typical personal and business telephone calls.

The voice mail system 100 forwards calls to contact numbers of service recipients 107 and then, if the service recipients 107 do not answer, the voice mail system 100 redirects the calls, records voice mail messages of the callers 102, and stores the recorded voice mail messages in voice mail inboxes 109 of the service recipients 107 for later retrieval and listening by the service recipients 107. In this regard, the voice mail system 100 accepts a missed call, plays an outgoing greeting message that identifies the particular service recipient whom a caller is trying to reach, and invites the caller to leave a recorded message for the particular service recipient. Preferably, the caller has an opportunity to review the recorded message and approve its delivery into a voice mail inbox of the service recipient, or to substitute the recorded message with a message prior to its delivery into the voice mail inbox. The process typically occurs seamlessly from the perspective of the callers 102, who may not even realize a voice mail system 100 is utilized by the service recipients 107.

Following missed calls, service recipients 107 are able to retrieve recorded voice messages from their voice mail in-boxes 109. For instance, following a missed call, a particular service recipient 108 contacts the voice mail system 100 to retrieve any recorded message from the missed caller from a respective inbox 110 of the service recipient 108. The voice mail to be retrieved may have been sent or recorded by any of callers 102. In accessing the voice mail system 100, the service recipient 108 may playback, save, and delete any particular recorded voice message.

The voice mail system 100 has any number of integrated or associated subsystems 104 for facilitating the receiving of calls, the playing of outgoing greetings, the recording of voice messages by callers of missed calls, and the delivering of recorded messages to voice mail inboxes of the service recipients. Moreover, a database 106 preferably is kept on a computer-readable medium such as, for example, one or more computer disk drives, which contains data necessary in performing these functions. This database 106 may include, for example, service recipient records 105 kept for the recording and retrieval of data regarding contact information of service recipients, service agreements and contracts of the service recipients, billing information of the service recipients, and call histories of the service recipients.

In accordance with a preferred embodiment of the present invention, voice mail message subscriptions to voice mail messages of one or more particular subject matters are offered in connection with the voice mail services of one or more of the service recipients 107. In accordance with these voice mail message subscriptions, each such service recipient—or subscriber—is able to elect to subscribe to voice mail messages pertaining to a particular subject matter that is of interest to that subscriber. The particular subject matter may be a sports topic, religious topic, political topic, or news topic, for example. In any event, the particular subject matters are predefined for selection by a subscriber.

In accordance with this preferred embodiment, the voice mail service provider offers to the service recipients 107 subscriptions to voice mail messages pertaining to one or more particular subject matters. At any given time, a sub-set of the service recipients likely will elect to subscribe to voice mail messages pertaining to the one or more particular subject matters.

By way of example, in FIG. 1 a particular recipient 114 elects or “opts in” to subscribe to voice mail messages pertaining to automobile racing. Furthermore, as can be seen in FIG. 1, subscription to voice mail messages pertaining to football and fishing also are offered, but recipient 114 does not elect subscriptions to those voice mail messages. The recipient 114 preferably makes the election to receive voice mail messages pertaining to automobile racing utilizing a graphical display user interface that is presented on one or more html pages of the Internet or a user accessible kiosk. Alternatively, the recipient 114 makes the election through an audio based options selection menu of the voice mail system 100 using a telephone, or through direct interaction with customer service representatives. This election also can be made through facsimile or postal mail.

Subscriber-specific records 111 are kept for the recipients electing subscriptions, and are maintained in the voice mail system 100 in association with the recipient records 105. In this regard, each of the recipient records 105 further preferably includes an identification of whether the respective recipient of that record has elected to “opt in” to get a voice mail message subscription, and a respective subscriber record is kept for a recipient who has made such an election. The recipient records 105 thereby identify those recipients who have elected to subscribe to voice mail messages pertaining to particular subject matters. The subscriber-specific records 111 themselves are used to keep track of subscriber preferences with respect to available options.

Thus, with particular regard to the particular recipient 114 who has elected to subscribe to voice mail messages pertaining to automobile racing, FIG. 1 illustrates that a subscription indicator, i.e., the “VM OPT-IN” box, in recipient record 116 has been checked, thereby identifying that recipient 114 is, in fact, a subscriber and that a corresponding subscriber record 118 exists. Referring to the corresponding subscriber record 118, FIG. 1 illustrates that a distribution indicator has been associated with the subscriber record 118, i.e., the check box 120 for automobile racing has been selected. This indicates that recipient 114 has elected to subscribe to voice mail messages pertaining to automobile racing.

FIG. 1 further illustrates that neither the distribution indicator for football nor fishing has been associated with the subscriber record 118, i.e., neither the check boxes for football nor fishing has been selected, and consequently, that recipient 114 has not elected to subscribe to voice mail messages pertaining to football or fishing.

As will be apparent from FIG. 1 and the foregoing description of the voice mail system, voice mail inbox 122 is specific to the recipient 114 and stores the recorded messages of missed calls for the recipient 114. In conjunction therewith, and in accordance with the election of recipient 114 as reflected in the subscriber record for recipient 114, voice mail messages pertaining to automobile racing are created and delivered to the voice mail inbox 122 of recipient 114 at periodic intervals. Indeed, as shown in FIG. 1, such a voice mail message 124 pertaining to automobile racing has been delivered to voice mail inbox 122 and awaits retrieval by recipient 114 (note that voice mail messages pertaining to a predefined subject matter are designated in FIG. 1 as “VM”).

According to a preferred embodiment, recipient 114 has agreed to pay one or more subscription fees in conjunction with electing to subscribe to one or more voice mail messages pertaining to one or more particular subject matters. The fee may be charged for each subscription to a particular subject matter, or the fee may be charged on a per message basis. For example the recipient may pay a fee for each subject voice mail message wherein the fee per message may be fixed or may vary with the length, subject, content, or quality of the subject voice mail message. Alternatively, the recipient may pay no fee for a subscription; the costs for the voice mail message services may be included in a fee for the basic voice mail services.

The voice mail message 124 may include any informative, entertaining, or valuable content related to automobile racing. Thus, as shown in FIG. 1, for example, the exemplary voice mail message 124 includes a voice recording of a telephonic interview with a famous automobile racecar driver 128. In particular, the driver 128 in this example is interviewed through a recorded telephone call between the driver and an interviewer. Alternatively, an interview can be recorded with a driver and an interviewer both present at a common location in a question and answer or discussion format. Another alternative within the scope of the present invention includes a monologue by the driver 128 on a relevant topic relating to automobile racing. In yet another alternative, the interviewer prepares questions or suggests topics for opinion, the driver's responses to the questions or the driver's opinion is recorded in creation of the voice mail message 124. The duration of the interview of the driver 128 preferably is approximately fifteen minutes, but other duration times are within the scope of the invention.

Furthermore, while a racecar driver 128 is illustrated as providing voice content for the voice mail message 124, it will be apparent to those having ordinary skill in the art that other racecar drivers, their spouses and family members, retired drivers, pit crew chiefs, racing team owners and sponsors, motor coach drivers, racing league officers or members such as NASCAR officials, and any other person related to automobile racing, are eligible for voice recording in voice mail messages such as voice mail message 124.

In preferred embodiments, services and benefits provided to a subscriber include outgoing greeting content that includes the recorded voice of a celebrity and that includes sound or music related to the subject matter of the subscription. For example a recipient electing to receive voicemail messages pertaining to racing are provided benefits such as a customized greeting to callers that includes the voice of a race car driver or racing celebrity. Moreover, offerings and provisions of promotions, contests, lotteries, one number follow me services, and friend referral incentives are within the scope of the present invention.

By way of example and not limitation, “subject matter” as used with regard to the foregoing preferred embodiment preferably comprises or consists of, singly or in any combination, the following individual topics: racing; automobile racing; a racing team; a racing driver; upcoming or past racing events; nostalgic racing stories; personal racing stories; perspectives on racing; racing histories; opinions on racing; information about one or more racing league; racing rules and specifications; racetracks and facilities; racing technologies; automobile specifications and categories; information about popular racecar drivers; expected winners and underdogs; and any content of potential interest to racing fans and recipients who elect to receive voice mail messages pertaining to racing.

The election of the recipient 114 to subscribe to voice mail messages pertaining to automobile racing and the creation and provision of a subject voice mail message 124 pertaining thereto has been discussed with reference to FIG. 1. As is apparent from FIG. 1, however, subscriptions to voice mail messages pertaining to other particular subject matters are offered within voice mail system 100. For example, with further regard to FIG. 1 and according to aspects of the present invention, the service system 100 conveys an offer to voice mail service recipients to subscribe to voice mail messages pertaining to each of automobile racing, professional football, and recreational or competitive bass fishing.

With particular regard to the recipient 134 who has elected to subscribe to voice mail messages pertaining to professional football, FIG. 1 illustrates that a subscription indicator box in a recipient record 136 has been checked, thereby indicating that recipient 134 is a subscriber and that a corresponding subscriber record 138 exists. FIG. 1 further illustrates that a check box 140 for football has been selected indicating that recipient 134 has elected to subscribe to voice mail messages pertaining to football.

As shown in FIG. 1, a voice mail inbox 142 is specific to the recipient 134 and receives recorded messages of missed calls for the recipient 134. In accordance with the election of recipient 134 as reflected in the subscriber record 138, voice mail messages pertaining to football are created and also delivered to the voice mail inbox 142 of recipient 134. Particularly, a voice mail message 144 of the subscription has been delivered to voice mail inbox 142.

The voice mail message 144 may include any content related to football. For example, as shown in FIG. 1, the voice mail message 144 includes a voice recording of a telephonic interview with a professional and noteworthy football player 148. Additionally, football player 148 may or may not be offered a payment for the interview in accordance with the present invention. Moreover, it will be apparent that, well within the scope of the invention, other football players, trainers, coaches, coordinators, commentators, and football celebrities and characters can provide voice recordings in voice mail messages such as voice mail message 144. Furthermore, an interview of any football related interviewee can be joined or facilitated by an interviewer. For example, a football savvy sports broadcaster, newsperson, coach, player, or commentator can participate in the creation of a voice mail message by acting as an interviewer or fellow interviewee.

By way of example and not limitation, “subject matter” as used with regard to the foregoing preferred embodiment preferably comprises or consists of, singly or in any combination, the following individual topics: a particular sport; a particular team; an association, conference, or region of teams; a particular high school; an association, conference, or region of high schools; a particular college; an association, conference, or region of colleges; a particular athlete or sports player; season statistics; player statistics; upcoming game predictions; perspectives and opinions; ticket availability information; recruiting and scouting information and gossip; profiles of opponent teams; injury updates and physician reports; discussions of game histories; league facts and trivia; discussions of players' diets and habits; personal stories; nostalgic stories; team and league politics and histories; game schedules; practice schedules; weather predictions for locations and times of upcoming games; information and predictions related to players changing teams; spring practices and games; preseason information; and any content of potential interest to sports fans and recipients who elect to receive voice mail messages pertaining to sports.

With particular regard to the recipient 154 who has elected to subscribe to voice mail messages pertaining to bass fishing, FIG. 1 illustrates that a subscription indicator box in a recipient record 156 has been checked, thereby indicating that recipient 154 is a subscriber and that a corresponding subscriber record 158 exists. FIG. 1 further illustrates that a check box 160 for bass fishing has been selected indicating that recipient 154 has elected to subscribe to voice mail messages pertaining to bass fishing.

As shown in FIG. 1, a voice mail inbox 162 is specific to the recipient 154 and stores recorded messages of missed calls for the recipient 154. In accordance with the election of recipient 154 as reflected in the subscriber record 158, voice mail messages pertaining to bass fishing are created and also delivered to the voice mail inbox 162 of recipient 154. Particularly, a voice mail message 164 has been delivered to voice mail inbox 162.

The voice mail message 164 may include any content related to bass fishing. For example, as shown in FIG. 1, the voice mail message 164 includes a voice recording of a telephonic interview with a known expert 168 at bass fishing. Bass expert 168 may or may not be offered a payment for the interview according to various aspects of the invention. Additionally, it will be apparent that, well within the scope of the invention, other bass experts, equipment providers, fish hatchery personnel, game wardens, and bass fishing celebrities and characters can provide voice recordings in voice mail messages such as voice mail message 164.

Furthermore, an interview of any fishing related interviewee can be joined or facilitated by any interviewer. For example a sports broadcaster, newsperson, commentator, or fishing enthusiast can participate in the creation of a voice mail message by acting as an interviewer or fellow interviewee.

By way of example and not limitation, “subject matter” as used with regard to the foregoing preferred embodiment preferably comprises or consists of, singly or in any combination, the following individual topics: any particular lake or waterway; any particular species or category of fish; fishing tournaments; weather reports for fishing locations; water levels and temperatures; dam pull times; water flow regulation schedules; fishing hot spots; fish population statistics; recommended lures and techniques; tournament information and statistics; bass fishing federation bulletins; league bulletins; board and member meeting notes; youth programs; member questions; advice for visiting or contacting lake facilities; fishing message boards; subscribers and experts tips and stories; and any content of potential interest to fishing fans and recipients who elect to receive voice mail messages pertaining to fishing.

In other embodiments (not illustrated) of the present invention, a voice mail system conveys an offer to voice mail service recipients to subscribe to voice mail messages pertaining to subject matters a particular profession. In one such embodiment, medical researchers in the field of epidemiology receive rapid breaking news updates related to disease incidents, reports, quarantines, and interdiction efforts. In another such embodiment, emergency response vehicle drivers receive voicemail messages pertaining to traffic congestion reports, travel time estimates, and medical facility overflow and referral reports. In another embodiment, astronomers receive voicemails pertaining to the latest sightings of astronomical phenomena. In yet another embodiment, legal professionals receive voicemail messages pertaining to legislative developments, trial schedules, regulatory updates, and case law decisions.

In similar fashion, in other such embodiments of the present invention, voicemail subscriptions may pertain to: accounting, banking, chemistry, diplomacy, engineering, fashion, geology, history, importing, journalism, kinesiology, library science, music, nuclear physics, photography, quality control, retailing, stock trading, translating, underwriting, vegetarianism, writing, extermination, and zoology.

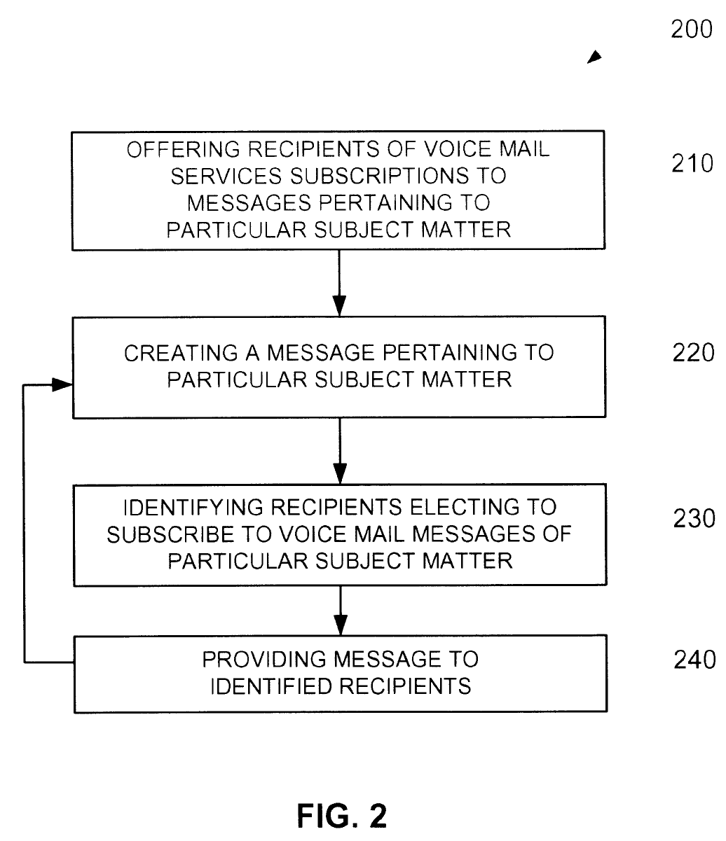

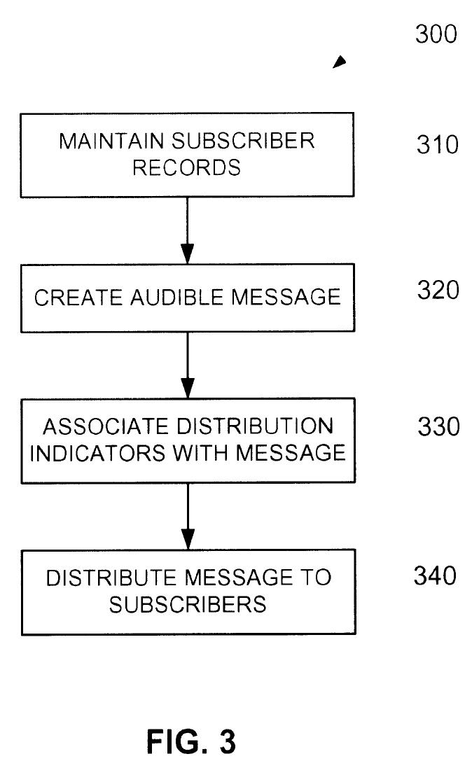

FIG. 2 illustrates a first flowchart of some basic steps 200 that are performed in the system of FIG. 1. These steps include offering 210 to recipients of voice mail services subscriptions to messages pertaining to a particular subject matter; creating 220 a message pertaining to the particular subject matter; identifying 230 recipients who have elected to subscribe to voice mail messages of the particular subject matter; and providing 240 the message to the identified recipients. Similar to FIG. 2, FIG. 3 also illustrates a flowchart of particular steps 300 that are performed (in the system of FIG. 1). These steps are performed in connection with the records of the database and include maintaining 310 subscriber records in the database; creating 320 an audible message pertaining to a particular subject matter (which in FIG. 1, the audible message represents a voice mail message); associating 330 a distribution indicator with the audible message; and distributing 340 the audible message to subscribers whose subscriber records have the distribution indicator associated with the audible message (which in FIG. 1, the distribution indicator represents selected check boxes of subscriber records 111).

Collectively, the steps 200 of FIG. 2 are performed by one entity or multiple entities working in coordination to provide the aforedescribed voice mail message subscriptions of FIG. 1. Similarly, the steps 300 of FIG. 3 are collectively performed by one entity or multiple entities working in coordination to provide the aforedescribed voice mail message subscriptions of FIG. 1. The entity performing these steps may be the voice mail service provider as discussed with reference to FIG. 1. However, in some preferred embodiments of the present invention, the voice mail service provider performs only a subset of these collective steps in the overall voice mail subscription system. In this regard, a voice mail message provider may work with the voice mail service provider, wherein the voice mail message provider is preferably responsible for creating voice mail messages pertaining to particular subject matters to which service recipients have elected to subscribe. In this model, interviews preferably would be handled by the voice mail message provider, and the voice mail message provider would provide the appropriate voice mail messages to the voice mail service provider for distribution to the appropriate subscribers. The voice mail service provider also may have some affiliation with the voice mail message provider, or the voice mail service provider may be completely independent of the voice mail message provider.

When there is both a voice mail service provider and a voice mail message provider, and if the voice mail message subscription service includes the step of charging a fee for the provision of the voice mail message pertaining to the particular subject matter, then preferred methods include the step of allocating the fee charged between the voice mail service provider and the voice mail message provider. The charged fee alternatively may be allocated between the voice mail service provider, the voice mail message provider, and an organization associated with the particular subject matter in circumstances where, for example, the organization assists the voice mail message provider in obtaining voice content relating to the particular subject matter. Furthermore, the provision of the subscription to voice mail messages pertaining to one or more particular subject matters preferably represents an optional add-on service to voice mail services that are provided or offered to service recipients.

Creating the voice mail messages preferably includes the step of recording the voice of a particular person. Preferably, the particular person is someone who is famous with respect to the particular subject matter to which the voice mail message being created pertains. For instance, the subject matter may be stock car racing and the person may be a racecar driver, or the subject matter may be a sports team and the person may be a coach or player on the team. In another instance, the subject matter may also be bass fishing and the person may be a recognized expert in bass fishing.

In order to engender loyalty and support for the voice mail message provider, all of the subscribers with respect to a particular subject matter preferably select, collectively, the particular person whose voice is recorded for one or more of the voice mail messages pertaining to that subject matter. The collective selection preferably is by vote of the subscribers, and to facilitate the vote and selection of an applicable person, a predefined group of willing candidates preferably is determined and presented to the applicable subscribers for the vote.

The present invention has been described in relation to particular embodiments which are intended in all respects to be illustrative rather than restrictive. Alternative embodiments will become apparent to those skilled in the art to which the present invention pertains without departing from its spirit and scope. Furthermore, any sequence(s) and/or temporal order of steps of various processes described and claimed herein are those considered to be the best mode contemplated for carrying out the present invention. Thus, it should be understood that, although steps of various processes may be shown and described as being in a preferred sequence or temporal order, the steps of any such processes are not limited to being carried out in any particular sequence or order, absent a specific indication of such to achieve a particular intended result. Indeed, the steps in such processes generally may be carried out in various different sequences and orders while still falling within the scope of the present invention. Accordingly, the scope of the present invention is defined by the appended claims rather than the foregoing description.

1. A method, comprising the steps of:
(a) offering, to a recipient of voice mail services, a subscription to voice mail messages pertaining to a particular subject matter; and
(b) providing to said recipient, pursuant to said offering, a voice mail message pertaining to the particular subject matter.

2. A method comprising the steps of:
(a) identifying recipients of voice mail services who have elected to subscribe to voice mail messages pertaining to a particular subject matter; and
(b) providing to said identified recipients a voice mail message pertaining to the particular subject matter.

3. A method, comprising the steps of:
(a) offering, to recipients of voice mail services, subscriptions to voice mail messages pertaining to one or more particular subject matters; and
(b) at periodic intervals,
(i) identifying those recipients who have elected to subscribe to voice mail messages of said offering, and
(ii) providing to said identified recipients a voice mail message of said offering.

4. The method of claim 3, wherein said step of offering includes offering to provide a subscription to voice mail messages pertaining to a single particular subject matter.

5. The method of claim 3, wherein said step of offering includes offering to provide a subscription to voice mail messages pertaining to a plurality of particular subject matters.

6. The method of claim 5, wherein subscription to voice mail messages is offered on a per subject matter basis.

7. The method of claim 6, further comprising the step of charging a subscription fee on a per subject matter basis.

8. The method of claim 5, further comprising receiving, from a particular recipient electing to subscribe to voice mail messages, an identification of a selection of particular subject matters out of the plurality of particular subject matters of said offering.

9. The method of claim 3, wherein said periodic intervals comprises days.

10. The method of claim 3, wherein said periodic intervals comprises weeks.

11. The method of claim 3, wherein said periodic intervals comprises months.

12. The method of claim 3, further comprising the step of charging a fee for the subscription to the voice mail messages of said offering.

13. The method of claim 3, wherein no fee is charged for the subscription to the voice mail messages of said offering.

14. The method of claim 3, wherein a particular subject matter comprises a sports topic.

15. The method of claim 3, wherein a particular subject matter comprises a political topic.

16. The method of claim 3, wherein a particular subject matter comprises a religious topic.

17. The method of claim 3, wherein a particular subject matter comprises a news topic.

18. A voice mail message subscription service including a method, the method comprising the steps of:
(a) offering to provide
(i) voice mail services and, in conjunction therewith,
(ii) a subscription to voice mail messages pertaining to one or more particular subject matters; and
(b) at periodic intervals,
(i) identifying recipients of the voice mail services of said offering who, pursuant to said offering, have elected to subscribe to the voice mail messages of said offering, and
(ii) providing to said identified recipients a voice mail message of said offering.

19. A voice mail message subscription service including a method, the method comprising the steps of:
(a) offering to provide, to recipients of voice mail services, subscriptions to voice mail messages pertaining to one or more particular subject matters; and
(b) at periodic intervals,
(i) identifying recipients of the voice mail services who, pursuant to said offering, have elected to subscribe to voice mail messages of said offering, and
(ii) providing to said identified recipients a voice mail message of said offering.

20. The method of claim 19, wherein said step of offering includes offering to provide a subscription to voice mail messages pertaining to a single particular subject matter.

21. The method of claim 19, wherein said step of offering includes offering to provide a subscription to voice mail messages pertaining to a plurality of particular subject matters.

22. The method of claim 21, wherein subscription to voice mail messages is offered on a per subject matter basis.

23. The method of claim 22, further comprising the step of charging a subscription fee on a per subject matter basis.

24. The method of claim 21, further comprising receiving, from a particular recipient electing to subscribe to voice mail messages, an identification of a selection of particular subject matters out of the plurality of particular subject matters of said offering.

25. The method of claim 19, wherein said periodic intervals comprise days.

26. The method of claim 19, wherein said periodic intervals comprise weeks.

27. The method of claim 19, wherein said periodic intervals are intermittent.

28. The method of claim 19, further comprising the step of charging a fee for the subscription to the voice mail messages.

29. The method of claim 19, wherein no fee is charged for the subscription to the voice mail messages.

30. The method of claim 19, wherein said step of providing to said identified recipients a voice mail message of said offering comprises the step of making a voice mail message of said offering accessible for listening by each of said identified recipients.

31. The method of claim 19, wherein said step of providing to said identified recipients a voice mail message of said offering comprises the step of, for each particular one of said identified recipients, playing the same digital audio file that represents said provided voice mail message of said offering.

32. The method of claim 19, wherein said step of providing to said identified recipients a voice mail message of said offering comprises the step of, for each particular said identified recipient, distributing to a voice mail inbox of the particular said identified recipient a digital audio file that represents said provided voice mail message of said offering.

33. The method of claim 19, wherein said step of providing to said identified recipients a voice mail message of said offering comprises the step of, for each particular said identified recipient, copying to a voice mail inbox of the particular said identified recipient a digital audio file that represents said provided voice mail message of said offering.

34. The voice mail message subscription service of claim 19, wherein a voice mail service provider that provides voice mail services to the recipients also performs the steps of the method.

35. The voice mail message subscription service of claim 34, wherein said step of providing the voice mail message comprises the steps, by the voice mail service provider, of receiving the voice mail message, and then making the voice mail message accessible through voice mail for recipient listening.

36. The voice mail message subscription service of claim 34, wherein said provided voice mail message is created by other than the voice mail service provider.

37. The voice mail message subscription service of claim 34, wherein said provided voice mail message is created by a voice mail message provider.

38. The voice mail message subscription service of claim 37, wherein said voice mail message provider is different from the voice mail service provider.

39. The voice mail message subscription service of claim 37, further comprising the step of charging a fee for said providing of the voice mail message pertaining to the particular subject matter.

40. The voice mail message subscription service of claim 39, further comprising the step of allocating said charged fee between the voice mail service provider and the voice mail message provider.

41. The voice mail message subscription service of claim 39, further comprising the step of allocating said charged fee between the voice mail service provider, the voice mail message provider, and an organization associated with the particular subject matter.

42. The voice mail message subscription service of claim 19, wherein the provision of a subscription to voice mail messages pertaining to one or more particular subject matters represents an optional add-on service to the voice mail services.

43. The method of claim 19, further comprising the step of creating said provided voice mail message of said offering.

44. The method of claim 43, wherein said step of creating said provided voice mail message of said offering includes the step of recording the voice of a particular person.

45. The method of claim 44, wherein the particular person comprises a person that is famous with respect to one or more particular subject matters of said offering.

46. The method of claim 44, wherein a subject matter of the one or more particular subject matters comprises stock car racing and the person comprises a driver.

47. The method of claim 44, wherein a subject matter of the one or more particular subject matters comprises a sports team and the person comprises a coach or player of the team.

48. The method of claim 44, wherein a subject matter of the one or more particular subject matters comprises bass fishing and the person comprises a recognized expert in bass fishing.

49. The method of claim 44, wherein said identified recipients collectively select the particular person.

50. The method of claim 43, wherein identified recipients vote to select the particular person.

51. The method of claim 43, wherein identified recipients vote to select the particular person out of a defined group of people.

52. The method of claim 19, wherein a particular subject matter of said offering comprises a sports topic.

53. The method of claim 52, wherein the sports topic pertains to a high-school sport, a college sport, a pro sport, or an Olympic sport.

54. The method of claim 52, wherein the sports topic pertains to baseball, football, basketball, hockey, soccer, tennis, golf, bowling, volleyball, fishing or hunting.

55. The method of claim 52, wherein the sports topic pertains to racing.

56. The method of claim 55, wherein the racing comprises automobile racing, boat racing, motorcycle racing, bicycle racing, foot racing, horse racing, or dog racing.

57. The method of claim 19, wherein a particular subject matter of said offering comprises a political topic.

58. The method of claim 19, wherein a particular subject matter of said offering comprises a religious topic.

59. The method of claim 19, wherein a particular subject matter of said offering comprises a news topic.

60. A method of providing audible messages that pertain to one or more particular subject matters to subscribers who have elected to receive the audible messages, the method comprising the steps of:
(a) maintaining subscriber specific records, each record including one or more distribution indicators of a respective subscriber, each distribution indicator corresponding to a particular subject matter for which the respective subscriber has elected to receive audible messages;
(b) creating an audible message pertaining to a certain one of the particular subject matters;
(c) associating a distribution indicator with said created audible message, said associated distribution indicator corresponding to the certain one of the particular subject matters; and
(d) distributing said created audible message to each subscriber whose record includes the distribution indicator corresponding to said associated distribution indicator of said created audible message.

61. The method of claim 60, wherein each subscriber specific record further includes a destination indicator for the subscriber.

62. The method of claim 61, wherein a destination indicator comprises a telephone number.

63. The method of claim 62, wherein a destination of the destination indicator comprises a telephone, a telephone answering machine, a voice mail inbox, or a telephone answering service.

64. The method of claim 61, wherein distributing the audible message comprises transmitting the audible message as a telephony signal in real time.

65. The method of claim 61, wherein distributing the audible message comprises transmitting the audible message in data packets.

66. The method of claim 61, wherein the audible message comprises a digital audio file.

67. The method of claim 61, wherein a destination indicator comprises an email address.

68. The method of claim 60, wherein distributing the audible message comprises distributing an indication of availability of the audible message.

69. The method of claim 60, further comprising, prior to the step of distributing the audible message, the step of generating an indication of availability of the audible message.

70. The method of claim 60, further comprising the step of receiving from a particular subscriber an election to receive audible messages pertaining to another particular subject matter, and including in the record of the particular subscriber a distribution indicator corresponding to this other particular subject matter.

71. The method of claim 60, further comprising the step of receiving from a new subscriber an election to receive audible messages pertaining to a particular subject matter, and generating a new record for the new subscriber, said generated record including a distribution indicator corresponding to the particular subject matter of the election.

72. The method of claim 60, wherein a particular subject matter comprises a sports topic.

73. The method of claim 60, wherein a particular subject matter comprises a political topic.

74. The method of claim 60, wherein a particular subject matter comprises a religious topic.

75. The method of claim 60, wherein a particular subject matter comprises a news topic.

76. An audible message subscription service, including a method comprising the steps of:
(a) identifying recipients who have elected to subscribe to audible messages pertaining to one or more predefined subject matters;
(b) creating an audible message pertaining to a particular one of the predefined subject matters; and
(c) providing said created audile message to said identified recipients.

77. The method of claim 76, further comprising the step of offering to provide subscriptions to audible messages pertaining to the predefined subject matters, and wherein said identified recipients have elected to subscribe to the audible messages in response to said offering.

78. The method of claim 77, wherein said step of offering includes offering to provide a subscription to audible messages pertaining to a single predefined subject matter.

79. The method of claim 77, wherein said step of offering includes offering to provide a subscription to audible messages pertaining to a plurality of predefined subject matters.

80. The method of claim 79, further comprising receiving, from a particular recipient electing to subscribe to audible messages, an identification of a selection of predefined subject matters out of the plurality of predefined subject matters of said offering.

81. The method of claim 76, further comprising repeating steps (b) and (c) at periodic intervals.

82. The method of claim 81, wherein said periodic intervals comprise days.

83. The method of claim 81, wherein said periodic intervals comprise weeks.

84. The method of claim 81, wherein said periodic intervals are intermittent.

85. The method of claim 76, wherein the predefined subject matter comprises a sports topic.

86. The method of claim 76, wherein the predefined subject matter comprises a political topic.

87. The method of claim 76, wherein the predefined subject matter comprises a religious topic.

88. The method of claim 76, wherein the predefined subject matter comprises a news topic.
